(19) United States
(12) Patent Application Publication
(10) Pub. No.: US 2022/0222900 A1
(43) Pub. Date: Jul. 14, 2022

(54) COORDINATING OPERATIONS WITHIN AN XR ENVIRONMENT FROM REMOTE LOCATIONS

(71) Applicant: Taqtile, Inc., Seattle, WA (US)

(72) Inventors: John TOMIZUKA, Seattle, WA (US); Dirck T. SCHOU, JR., Bainbridge Island, WA (US)

(21) Appl. No.: 17/149,215

(22) Filed: Jan. 14, 2021

(51) Int. Cl. G06T 19/00

(52) U.S. Cl. CPC G06T 19/006; G06T 2219/024

(57) ABSTRACT

Coordinating operations within an XR environment from remote locations include executing an XR collaboration application to provide a virtual reality experience within an XR environment representing a real-world environment on a user device. A representation of an object within the XR environment may be rendered on a user interface of the user device. An additional user device located at a remote location may provide user input. In response to the user input, an edited representation of the object may be generated based at least on a viewpoint of the object from the additional user device. The edited representation of the object may be rendered on the user interface of the user device, the edited representation of the object may correspond to the viewpoint of the object from the additional user device.

### BACKGROUND

Presently, consumers may experience several different modes of virtual experiences via appropriately enabled user devices. In one example, the user experience may derive solely from computer-generated content executed via a virtual reality (VR) enabled device, which can provide a fully computer-generated visual experience that appears to surround the user. In another example, the user experience may derive from virtual content that overlays real-world content via an augmented reality (AR) device. In other words, the user experience may be comprised of a real-world experience that is augmented to include at least some computer-generated content. In yet another example, the user experience may derive from a combination of VR and AR, generated denoted as mixed reality (MR). While the term MR is intended to be more inclusive, it still excludes pure VR experiences. To cover all modes, the term extended reality (XR) may be used.

Applications such as an authoring tool may be used to define virtual content and related actions that allow for the creation and modification of workflow applications with multiple virtual environments. The authoring tool may receive and render for presentation, or other uses, the virtual content, via user devices. However, creating and modifying virtual content and interacting with various assets within virtual environments may rely upon collaboration among multiple users that are located in different physical locations. Accordingly, in cases where such collaboration is desired, collaborators may view and interact with the same XR assets. In this regard, representations of XR assets may need to be adjusted to better track and more accurately render work being performed in real-time.

### BRIEF DESCRIPTION OF THE DRAWINGS

The detailed description is described with reference to the accompanying figures, in which the leftmost digit(s) of a reference number identifies the figure in which the reference number first appears. The use of the same reference numbers in different figures indicates similar or identical items.

FIG. 1 illustrates an example of a network architecture for coordinating operations within an XR environment for a plurality of collaborators in different locations.

FIG. 2 is a flow diagram of rendering a perspective of a collaborator operating in an XR environment on a user interface of a user device located in a remote location.

FIG. 3 is a block diagram showing various components of an illustrative computing device that implements an XR collaboration application.

FIG. 4 is a flow diagram of an example process for sharing virtual experiences within an XR environment with multiple collaborators in different locations.

FIG. 5 is a flow diagram of an example process for coordinating views of an object for multiple collaborators within an XR environment.

### DETAILED DESCRIPTION

This disclosure is directed to techniques for interacting with remote users and synchronizing operations within an XR environment. In one aspect, an XR collaboration application may be configured to provide an XR environment via a head-mounted device (HMD), a handheld device, and/or other types of XR capable user devices that may be operated by a user. The XR capable user devices may be equipped with various sensors for receiving user input, which may comprise sensor data (e.g., movement data, gestures, speech input) and environmental data (e.g., location data). The XR environment may represent a real-world environment and may include various XR assets such as one or more objects. The XR collaboration application may receive a user command from an XR author to interact with the one or more objects. The objects can be associated with one or more virtual content that may be created, developed, and/or modified by an XR author via the XR collaboration application. The one or more virtual content can include annotations or markers associated with the object. Additionally, the virtual content may be associated with one or more functions or routines.

In some aspects, the XR collaboration application provides a collaborative platform for allowing multiple users from different physical locations to interact with the same XR assets in an XR environment. In one example, the XR environment may include a first user that is physically located in a first location and a second user that is physically located in a second location. The users may interact with one another within the XR environment. Additionally, or alternatively, the first user may observe the second user while the second user is operating within the XR environment.

In some aspects, the second user may, via the XR collaboration application, interact with an XR asset such as an object within the XR environment. The object may be a virtual object or a representation of a real object that is in a real-world environment that is represented in the virtual environment. In the latter case, the object may be located at the second location and accessible by the second user. In one example, the second user may interact with the object by physically manipulating the object. In another example, the second user may interact with the object by creating and/or associating one or more virtual content with the object. In some aspects, the object may be physically located with the first user at the first location. In this example, the second user may view a rendering of a representation of the object in an XR environment to virtually interact with the object within an XR environment.

As the second user interacts with the object, the XR collaboration application enables the first user device that is operated by the first user to display the object, wherein the display may have a perspective that is based on the second user's viewpoint of the object. In this way, the first user device may provide a first-person point of view of the object to the first user while the first user and the second user are located in different physical locations.

In some aspects, the XR collaboration application may, based at least on sensor data and/or user input received via the second user device that is operated by the second user, determine the second user's viewpoint position and orientation relative to the object. The second user's viewpoint position and orientation may be substantially the same as the position and orientation of the second user device. Accordingly, the XR collaboration application may determine the field of view of the second user device based at least on the user's viewpoint position and the orientation. The object may be positioned within the second user device's field of view. Within the user device's field of view, the XR collaboration application may identify a line of sight to the object. In some aspects, the XR collaboration application may further determine the position of the second user's eyes based at least on the line of sight, wherein the position of the second user's eyes may substantially correspond to the line of sight.

The XR collaboration application may in turn determine the viewpoint of the object from the second user device based at least on the second user's viewpoint position and orientation and the line of sight to the object. Upon determining the viewpoint of the second user, the XR collaboration application may render, on a user interface of the first user device, a representation of the object that corresponds to the viewpoint of the object from the second user device.

Accordingly, displaying an object and other XR assets from different perspectives depending upon a user's viewpoint with respect to the object may provide a more synchronized approach to facilitate collaboration among multiple users in different locations. The techniques described herein may be implemented in a number of ways. Example implementations are provided below with reference to the following figures.

Example Network Architecture

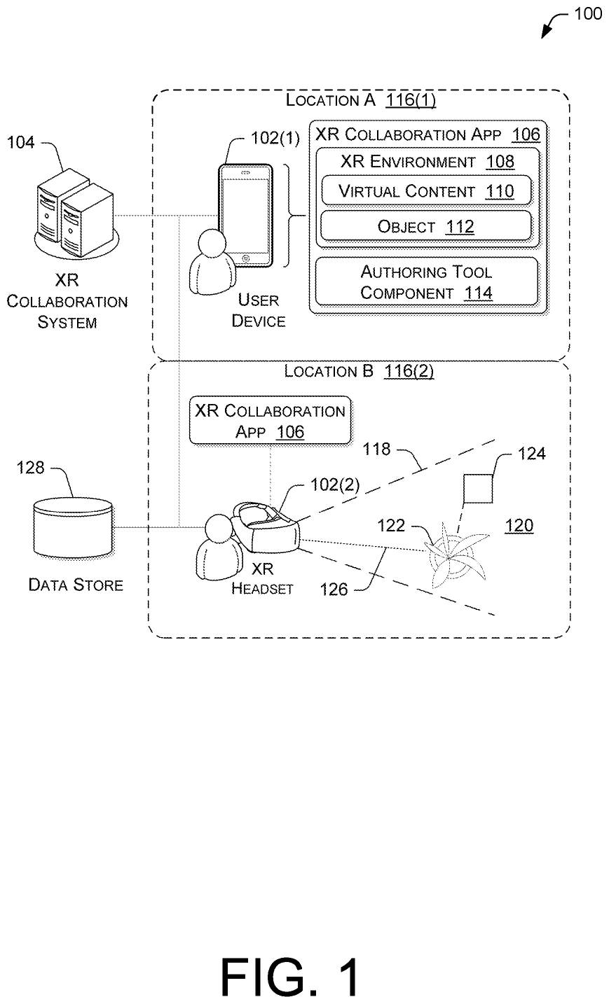

FIG. 1 illustrates an example of a network architecture for coordinating operations within an XR environment for a plurality of collaborators in different locations. The network 100 includes one or more user devices, such as user devices 102(1) and 102(2), that may be in communication with an XR collaboration system 104 configured to provide a virtual experience in an XR environment. In FIG. 1, user devices can include various VR, AR, and MR user equipment, such as a head-mounted device (HMD) or a headset. The user devices may also include smartphones, mobile devices, personal digital assistants (PDAs), or another electronic device having a wireless communication function that is capable of receiving input, processing the input, and generating output data to facilitate an augmented reality platform and/or a virtual reality platform. The user devices 102(1) and 102(2) may be equipped with various hardware such as sensors for receiving user input and obtain environmental data. For example, the sensors can include touch screens that accept gestures, microphones, voice or speech recognition devices, cameras or image capturing devices, accelerometers, gyroscopes, positioning devices (e.g., head positioning devices), and any other suitable devices.

The user devices 102(1) and 102(2) are connected to a network utilizing one or more wireless base stations or any other common wireless or wireline network access technologies. In FIG. 1, the network 100 can be a cellular network that implements 2G, 3G, 4G, 5G, and long-term evolution (LTE), LTE advanced, high-speed data packet access (HSDPA), evolved high-speed packet access (HSPA+), universal mobile telecommunication system (UMTS), code-division multiple access (CDMA), global system for mobile communications (GSM), a local area network (LAN), a wide area network (WAN), and/or a collection of networks (e.g., the Internet).

The XR collaboration application 106 may be implemented on user devices 102(1) and 102(2) associated with an XR author, a collaborator, and/or other types of users. The XR collaboration application 106 may be executable via one or more hardware, software, or communication environments, each of which enables the presentation of an XR environment 108 and development of virtual content 110 within the XR environment 108. The virtual content 110 can include graphical content such as images, including charts, graphs, icons, symbols, and/or so forth. The virtual content 110 can also include textual content and/or multimedia content such as audio, animation, and video. The XR environment 108 may represent a real-world environment. The XR environment 108 may include one or more objects 112 with which users can interact. The one or more objects 112 can be real objects or virtual objects that represent real objects in a real-world environment represented in the XR environment 108. The objects 112 may be associated with one or more virtual content 110. The XR collaboration application 106 may be configured to receive a user command from an XR author or other users to interact with the one or more objects 112 within the XR environment 108.

In one example, a user command can include speech inputs, gesture inputs, eye tracking inputs, motion inputs, and/or any other suitable input type. Accordingly, the XR collaboration application 106 may detect and recognize particular gestures performed by an XR author or other users that indicate an intention to add, modify, or delete an association between virtual content 110 and one or more objects 112 within the XR environment 108. For example, a first hand gesture (e.g., a swiping hand motion from left to right) may indicate that the XR author intends to add virtual content, while a second hand gesture (e.g., a swiping hand motion from right to left) may indicate that the XR author intends to remove virtual content. Various combinations of gestures may be possible, depending upon embodiments.

The XR collaboration application 106 and related techniques as described herein may also be used in a number of platform contexts for viewing, editing, creating, and manipulating virtual content 110. In one example, the XR collaboration application 106 may implement an authoring tool component 114. The user devices 102(1) and 102(2) may be configured with an XR application interface that may provide an XR author with a user interface (UI) capable of utilizing the authoring tool component 114 to facilitate the creation and modification of virtual content 110 within the XR environment 108. In some aspects, the authoring tool component 114 may enable multiple XR authors or users to collaborate to create and modify virtual content 110 within the XR environment 108 from different locations. In this way, the user devices 102(1) and 102(2) are configured to interact with an application programming interface (API) of a remote server, which receives and sends responses.

In FIG. 1, the first user device 102(1) may be operated by a first user that is located in a first location 116(1) and the second user device 102(2) may be operated by a second user that is located in a second location 116(2). The XR collaboration application 106 may provide a virtual reality experience within an XR environment by rendering on a user interface (e.g., a display screen) of each of the user devices 102(1) and 102(2), a representation of an object within the XR environment.

In one example, the object 112 may be a real object that is located at the first location 116(1) and the XR environment 108 may represent a real-world environment at the first location 116(1). The first user may interact with the object 112 at the first location 116(1) via the first user device 102(1) executing the XR collaboration application 106. For instance, the first user may physically manipulate the object 112 by changing the position of the object 112 in a real-world environment that is represented as the XR environment 108. In another instance, the first user may create one or more virtual content 110 and associate the virtual content 110 with the object 112 within the XR environment 108 via the authoring tool component 114.

In some aspects, the XR collaboration application 106 may further include a spatial mapping component to determine the position of the object 112 in the XR environment. The position of the object 112 may be the location (e.g., a specified area, room, defined space, etc.) or coordinates of the object 112. Accordingly, the position information of the object 112 may include x, y, and z coordinates within a defined space in the XR environment 108. The position information may be relative or absolute. Additionally, the position information may also include, yaw, pitch, and roll information, depending upon embodiments.

The object 112 may be positioned within a field of view of the first user device 102(1) and displayed on a user interface of the first user device 102(1). The display may have a perspective that is based on the first user's viewpoint of the object 112. The viewpoint may refer to a viewpoint of a user and/or a user device, wherein the viewpoint of the user and the user device may be the equivalent or substantially similar. Accordingly, the viewpoint of the user may be interchangeably used with the viewpoint of the user device. Additionally, the viewpoint may specify a location and/or orientation within an XR environment.

In some aspects, the XR collaboration application 106 may, based at least on sensor data and/or user input received via the first user device 102(1), identity its location coordinates and angular position to determine the first user's position (i.e., viewpoint position) and orientation relative to the object 112. The XR collaboration application 106 may determine the first user device's 102(1) field of view based at least on the position and orientation of the first user device 102(1). The object 112 may be included within the first user device's 102(1) field of view. The XR collaboration application 106 may identify the line of sight 126 to the object 112. The viewpoint of the object 112 from the first user device 102(1) may be determined based at least on the position and orientation of the first user device 102(1) and the line of sight 126. The XR collaboration application 106 may render, on a user interface of the second user device 102(2), a representation of the object 112 that corresponds to the viewpoint of the first user that operates the first user device 102(1).

The second user device 102(2) may be configured to reproduce the representation of the object 112 from the viewpoint of the first user. As the first user interacts with the object 112, an edited representation of the object 112 may be generated via the XR collaboration application 106 and rendered on the user interface of the second user device 102(2) at the second location 116(2). In this way, the second user that operates the second user device 102(2) at the second location 116(2) may view the perspective of the first user at the first location 116(1). In some aspects, the representation of the object 112 may be displayed as a hologram display or an overlay to a real-world environment at the second location 116(2).

In another example, the object may be a real object that is located at the second location 116(2) and the XR environment 120 may represent a real-world environment at the second location 116(2). The first user and/or the second user may interact with the object 122 at the second location 116(2) using respective user devices 102(1) and 102(2) that are configured to execute the XR collaboration application 106. For instance, the second user may physically manipulate the object 122 by changing the position of the object 122 in a real-world environment that is represented as the XR environment 120. Additionally, the first user may, as the second user is physically manipulating the object 122, create one or more virtual content 124 and associate the virtual content 124 with the object 122 within the XR environment 120 via the authoring tool component 114 of the XR collaboration application 106.

In some aspects, the first user and the second user may take turns and hand off tasks to one another in real-time after completion of each task. In this example, the second user may interact with the object 122 at the second location 116(2). The object 122 may be positioned within a field of view 118 of the second user device 102(2) and displayed on a user interface of the second user device 102(2). The display may have a perspective that is based on the second user's viewpoint of the object 122. The viewpoint of the second user may be based at least on the position and orientation of the user device 102(2) and the line of sight 126 to the object 122 within the second user device's 102(2) field of view.

The representation of the object 122 from the viewpoint of the second user at the second location 116(2) may be transmitted to the first user device 102(1) at the first location 116(1). The first user device 102(1) may be configured to reproduce the representation of the object 122 from the viewpoint of the second user. As the second user interacts with the object 122, an edited representation of the object 122 is generated via the XR collaboration application 106 and rendered on the user interface of the first user device 102(1) at the first location 116(1). Continuing with the example of handing off tasks, the second user may hand off successive tasks to the first user. In response to receiving successive tasks, the first user may rely on the viewpoint of the second user to interact with the object 122 and complete the successive tasks.

In yet another example, the object 122 may be a virtual object. The object 122 may be presented as a hologram display or an overlay to a real-world environment at the first location 116(1) and/or the second location 116(2). Additionally, the first user and the second user may interact with the object 122 concurrently and/or in a predetermined order. In some aspects, the XR collaboration application 106 may provide a messaging feature (e.g., instant messaging, voice calling, video calling, electronic mail, and/or any combination thereof) for facilitating communication between the first user and the second user. Further, the XR collaboration application 106 may keep track of interactions with the object 122 to identify and associate each transaction involving an interaction with a specific user.

In some aspects, the XR collaboration application 106 may also reside on a remote server of the XR collaboration system 104. The XR collaboration system 104 is configured to perform certain operations, including but not limited to receiving data from and writing to an arbitrary user interface for any virtual experience mode, performing 3-dimensional (3D) data visualization and analysis between users, enabling XR authors to maintain 3D models and virtual experiences, maintain XR collaboration applications, providing a common set of collaborative experiences, and making use of a common set of lower-level XR collaborative facilities, including for object placement, sharing, control management, and data sharing. The remote server that may be configured to execute the XR collaboration application 106 based on inputs received from the user devices 102(1) and 102(2) that are communicatively coupled via the network 100. In this example, the user devices 102(1) and 102(2) may capture inputs from an XR author and further communicate the inputs to the XR collaboration system 104.

The XR collaboration system 104 may include general-purpose computers, such as desktop computers, tablet computers, laptop computers, servers (e.g., on-premise servers), or other electronic devices that are capable of receiving input, processing the input, and generating output data. The XR collaboration system 104 may include a plurality of physical machines that may be grouped and presented as a single computing system. Each physical machine of the plurality of physical machines may comprise a node in a cluster. Additionally, or alternatively, the XR collaboration system 104 may include virtual machines, such as virtual engines (VE) and virtual private servers (VPS).

The XR collaboration system 104 may store data in a distributed storage system, in which data may be stored for long periods and replicated to guarantee reliability. For example, the XR collaboration system 104 may access the distributed storage system such as data store 128 that correspond to a third-party data store where virtual contents and other XR assets are stored. The data store 128 can comprise a data management layer that includes software utilities for facilitating the acquisition, processing, storing, reporting, and analysis of data. In various embodiments, the data store 128 can be configured with an API that can be called by an application or interface with an API of the application for providing data access.

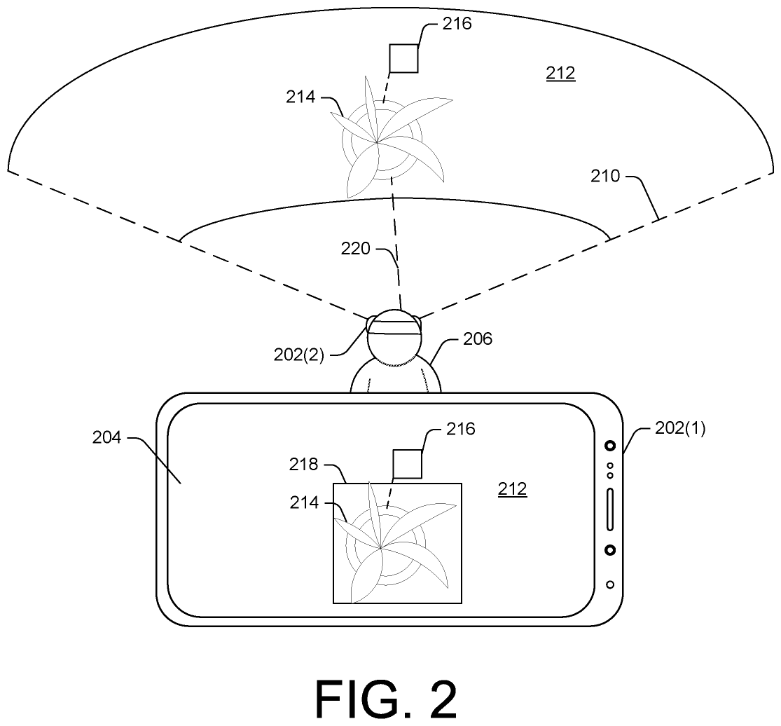

In some aspects, the XR collaboration system 104 may receive a request from user devices to share a virtual experience within an XR environment with multiple users. For example, a first user may transmit a request, via the first user device 102(1), to the XR collaboration system 104, to transmit a rendering of a representation of an object in an XR environment for display via the second user device 102(2). The rendering of the representation of the object may correspond to the first user's perspective of the object as further discussed with respect to FIG. 2.

FIG. 2 is a flow diagram of rendering a perspective of a collaborator operating in an XR environment on a user interface of a user device located in a remote location. FIG. 2 includes a first user device 202(1) and a second user device 202(2). The first user device 202(1) and the second user device 202(2) may correspond to the first user device 102(1) and the second user device 102(2) of FIG. 1, respectively. Accordingly, the user devices 202(1) and 202(2) may be configured with an XR application interface that may provide a user with a UI that is capable of facilitating interaction with various XR assets such as an object 214 within the XR environment 212. The first user device 202(1) may be operated by a first user that is located in a first location and the second user device 202(2) operated by a second user 206 that is located in a second location. While FIG. 2 includes two users in two different locations, additional users may participate or join as collaborators in various embodiments.

The second user device 202(2) may enable the second user 206 to interact with the object 214 and/or the virtual content 216 associated with the object 214 in the XR environment 212. For instance, the second user 206 may modify the virtual content 216, create additional virtual content, associate the virtual content 216 with components of the object 214, and/or perform other operations within the XR environment 212. In some aspects, the second user device 202(2) may implement sensors such as gyroscopes and head position sensors to determine the position and orientation of the user 206 (and hence the second user device 202(2)) relative to the object 214 in the XR environment 212. Additionally, the position of the object 214 may be mapped within the XR environment 212 via a spatial mapping component of the XR collaboration application. Additionally, or alternatively, the position of the object 214 may be known and stored in a data store where the position information of the object 214 may be retrieved in response to a request from the second user device 202(2).

In FIG. 2, the object 214 may be positioned within a field of view 210 of the second user device 202(2) and therefore within the second user's 206 line of sight 220. In some aspects, the position of the second user's 206 eyes may also be determined based at least on the second user's 206 line of sight 220 as the second user's 206 eyes may gaze towards the object 214 (e.g., when the second user 206 interacts with the object 214). The viewpoint 218 of the second user 206 may be based at least on the position and orientation of the second user 206 relative to the object 214 and the line of sight 220. Based at least on the viewpoint 218 of the second user 206, the XR collaboration application may generate a representation of the object 214 for display on the user interface 204 of the first user device 202(1) at the first location. The first user device 202(1) may reproduce the representation of the object 214 within the XR environment 212 from the viewpoint 218 of the second user 206.

### Example Computing Device Components

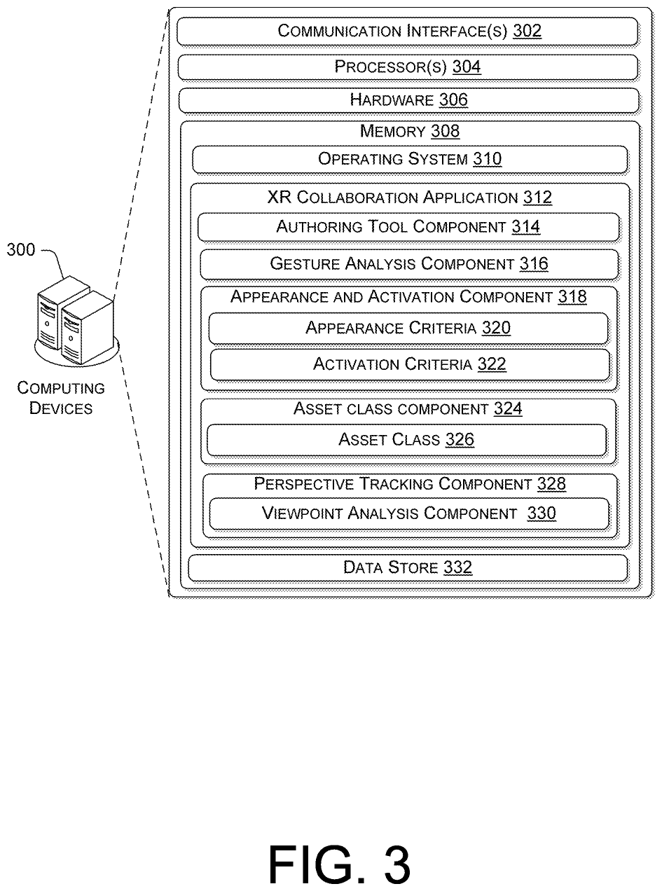

FIG. 3 is a block diagram showing various components of illustrative computing devices depicted in FIG. 1. It is noted that the computing devices 300 as described herein can operate with more or fewer of the components shown herein. Additionally, the computing devices 300 as shown herein or portions thereof can serve as a representation of one or more of the computing devices of the present system.

The computing devices 300 may include a communication interface 302, one or more processors 304, hardware 306, and memory 308. The communication interface 302 may include wireless and/or wired communication components that enable computing devices 300 to transmit data to and receive data from other networked devices. In at least one example, the one or more processor(s) 304 may be a central processing unit(s) (CPU), graphics processing unit(s) (GPU), both a CPU and GPU, or any other sort of processing unit(s). Each of the one or more processor(s) 304 may have numerous arithmetic logic units (ALUs) that perform arithmetic and logical operations as well as one or more control units (CUs) that extract instructions and stored content from processor cache memory, and then execute these instructions by calling on the ALUs, as necessary during program execution.

The one or more processor(s) 304 may also be responsible for executing all computer applications stored in the memory, which can be associated with common types of volatile (RAM) and/or nonvolatile (ROM) memory. The hardware 306 may include additional user interface, data communication, or data storage hardware. For example, the user interfaces may include a data output device (e.g., visual display, audio speakers), and one or more data input devices. The data input devices may include but are not limited to, combinations of one or more of keypads, keyboards, mouse devices, touch screens that accept gestures, microphones, voice or speech recognition devices, and any other suitable devices.

The memory 308 may be implemented using computer-readable media, such as computer storage media. Computer-readable media includes, at least, two types of computer-readable media, namely computer storage media and communications media. Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanisms. The memory 308 may also include a firewall. In some embodiments, the firewall may be implemented as hardware 306 in the computing devices 300.

The processor(s) 304 and the memory 308 of the computing devices 300 may implement an operating system 310, an XR collaboration application 312, and a data store 332. The data store 332 can comprise a data management layer that includes software utilities for facilitating the acquisition, processing, storing, reporting, and analysis of data. In one example, the data store 332 may store XR templates, XR, or virtual content (e.g., markers), objects, and/or so forth. In various embodiments, the data store 332 can be configured with an API that can be called by an application or interface with an API of the application for providing data access.

The operating system 310 may include components that enable the computing devices 300 to receive and transmit data via various interfaces (e.g., user controls, communication interface, and/or memory input/output devices), as well as process data using the processor(s) 304 to generate output. The operating system 310 may include a presentation component that presents the output (e.g., display the data on an electronic display, store the data in memory, transmit the data to another electronic device, etc.). Additionally, the operating system 310 may include other components that perform various additional functions generally associated with an operating system.

The XR collaboration application 312 may include routines, program instructions, objects, and/or data structures that perform particular tasks or implement particular abstract data types. For example, the XR collaboration application 312 may include one or more instructions which, when executed by the one or more processors 304, direct the computing devices 300 to perform operations related to creating, editing, modifying, viewing, and retrieving virtual content. The XR collaboration application 312 comprises an authoring tool component 314, a gesture analysis component 316, an appearance and activation component 318, an asset class component 324, and a perspective tracking component 328.

The authoring tool component 314 may include one or more instructions which, when executed by the one or more processors 304, direct the computing devices 300 to perform operations related to creating, editing, modifying, viewing, and retrieving virtual content. The authoring tool component 314 enables a user (i.e., an XR author) to create and place virtual content (e.g., textual and/or multimedia content) such as markers or other graphical indicia in an XR environment. The virtual content may be associated with a real-world item or an object in the XR environment. The authoring tool component 314 may also be used to change the behavior of the virtual content.

Additionally, one or more rules may be applied to enable the virtual content to appear in an XR environment. In one example, virtual content may always be visible in an XR environment or presented to a user appear in response to a gesture or a user input to activate the content. In another example, one or more pins may appear in an XR environment in a predetermined order in response to deciding that one or more prerequisite pins had been activated and the content has been presented or viewed.

The authoring tool component 314 may be configured to add, change, or remove markers, content, and behavior as desired by performing manipulations within an XR environment. In some aspects, a user may make a gesture to perform manipulations within an XR environment. The manipulations may be made from scratch or an existing template. The authoring tool component 314 may then record the changes, which may be stored locally at a user device's storage or in a data store.

The gesture analysis component 316 may include one or more instructions which, when executed by the one or more processors 304, direct the computing devices 300 to perform operations related to capturing and quantifying a gesture performed by a user via an XR environment-enabled user device. In some examples, the gesture analysis component 316 may compare a captured gesture against stored gestures within an XR template to determine whether the gesture in an indicator for revealing virtual content, forgoing a presentation of virtual content, or dismissing a marker. Moreover, the gesture analysis component 316 may also monitor the user's interaction within an XR environment. In some aspects, the gesture analysis component 316 may implement machine learning algorithms to analyze the user's actions and determine whether those actions are consistent with instructions annotated or recorded within corresponding virtual content.

The appearance and activation component 318 may include one or more instructions which, when executed by the one or more processors 304, direct the computing devices 300 to perform operations related to generating appearance criteria 320 that are associated with markers and activation criteria 322 that are associated with the virtual content of an XR template. Appearance criteria 320 may be configured to control when markers display within an XR environment. Appearance criteria 320 may cause one or more markers to become visible or remain visible based on the fulfillment of a predetermined condition. The predetermined condition may be set by the user and may be based on threshold environmental data, such as a threshold temperature, a threshold noise level, a threshold light intensity, a threshold moisture level, a threshold odor intensity, or any other pertinent data. alternatively, or additionally, the predetermined condition may be based on the user being within a predetermined proximity of a physical object within the XR environment.

Activation criteria 322 may be configured to control when the virtual content associated with a marker is displayed within the XR environment. In some examples, the activation criteria 322 may comprise one or more gestures performed by an application user that is interacting with an XR template within the XR environment. Activation criteria 322 may be configured to reveal virtual content, forgo a presentation of virtual content, or dismiss a presentation of a marker. While activation criteria 322 may correspond to the one or more gestures performed by the user, other types of activation criteria 322 are possible. For example, activation criteria 322 may be based on one or more of an audible command, time, temperature data, light intensity data, moisture data, noise data, weather data, odor data, or any other form of pertinent data deemed relevant by the user.

The asset class component 324 may include one or more instructions which, when executed by the one or more processors 304, direct the computing devices 300 to perform operations related to dynamically generating asset classes of virtual content, appearance criteria 320, and activation criteria 322 that relate to a common marker (i.e., a physical object) within an XR template. A common marker may correspond to instances of the same type of physical object or virtual object. An asset class 326 may include virtual content, appearance criteria 320 (i.e., markers), and activation criteria 322 (i.e., virtual content). By grouping virtual content and corresponding criteria that relate to the same type of physical or virtual object, the asset class component 324 can simplify the proliferation of virtual content with the XR environment.

Further, the asset class component 324 may generate a sub-asset class to account for variations in a type of physical object or virtual object within an XR environment. Thus, Physical Object B that differs slightly from Physical Object A may be presented by an asset class of Physical Object A and a sub-asset class that accounts for the differences between Physical Objects A and B.

The perspective tracking component 328 may include one or more instructions which, when executed by the one or more processors 304, direct the computing devices 300 to perform operations related to determining the viewpoint of a user that is operating within an XR environment. The perspective tracking component 328 may receive sensor data from one or more sensors (e.g., sensor fusion) of the computing devices 300 to determine the position and orientation of the user relative to an object (i.e., an XR asset) with which the user interacts within the XR environment. The position and the orientation information may be used to determine a user device's field of view within the XR environment.

Additionally, the position and the orientation information may be used to determine the user device's distance from the object. Based at least on the distance, the perspective tracking component 328 may calculate the optical zoom for display. Irrespective of the distance, the object may be positioned within the field of view. The perspective tracking component 328 may identify the line of sight to the object from the user. The line of sight may be unobstructed to form a visual axis between the user and the object. Based at least on the position and orientation information and the line of sight, the perspective tracking component 328 may determine the viewpoint of the object from the user's perspective.

The viewpoint analysis component 330 may include one or more instructions which, when executed by the one or more processors 304, direct the computing devices 300 to perform operations related to generating a representation of an object and/or an object that corresponds to the viewpoint of the object from the user's perspective. Upon determining the viewpoint, the viewpoint analysis component 330 may identify and/or render an image or a view of an object with which the user interacts within the XR environment that corresponds with the viewpoint of the object from the user's perspective. Updated views or representations of the object may be generated and then rendered on a user interface of a user device. For instance, the viewpoint analysis component 330 may determine that a first viewpoint of the object from the user's perspective is different from a second viewpoint of the object. In response to determining that the second viewpoint is different from the first viewpoint, the viewpoint analysis component 330 may generate an edited representation of the object and render, on the user interface of the user device, the edited representation of the XR asset. In some embodiments, the viewpoint analysis component 330 may generate an edited representation by shifting from an original viewpoint to a new viewpoint with respect to a 3D model for the object. The 3D model may be constructed from model data that includes object files, meshes, textures, shaders, 2-dimensional (2D) images, and/or other image data. In some instances, the viewpoint analysis component 330 may further modify the color properties for the portion of the 3D model visible from the new viewpoint based on the lighting conditions at the new viewpoint. For example, the lighting conditions may include one or more light source positions, light level, light temperature, reflectiveness of the object at the new viewpoint, reflectiveness of other objects at the new viewpoint, and/or so forth.

### Example Processes

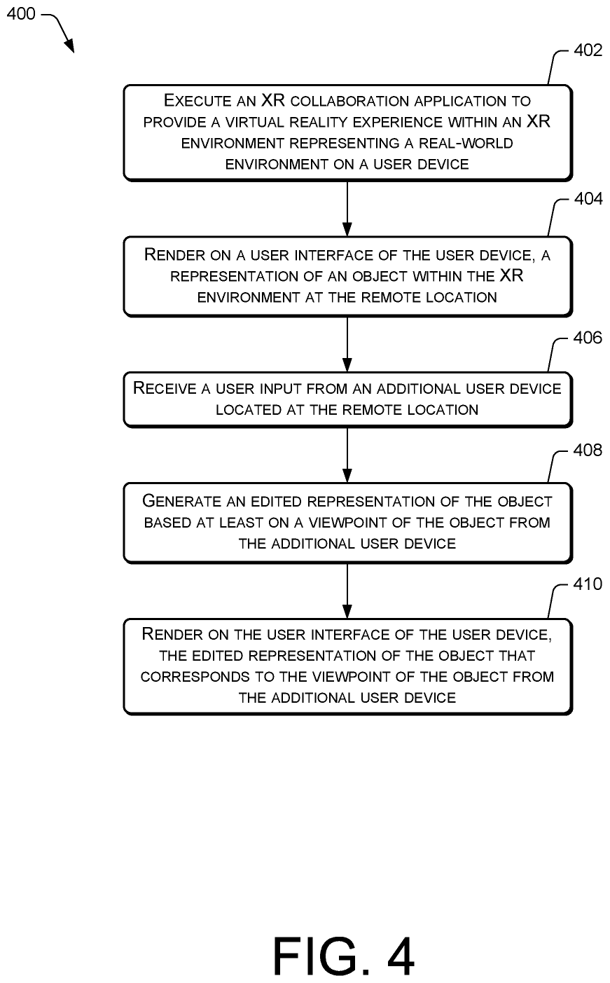

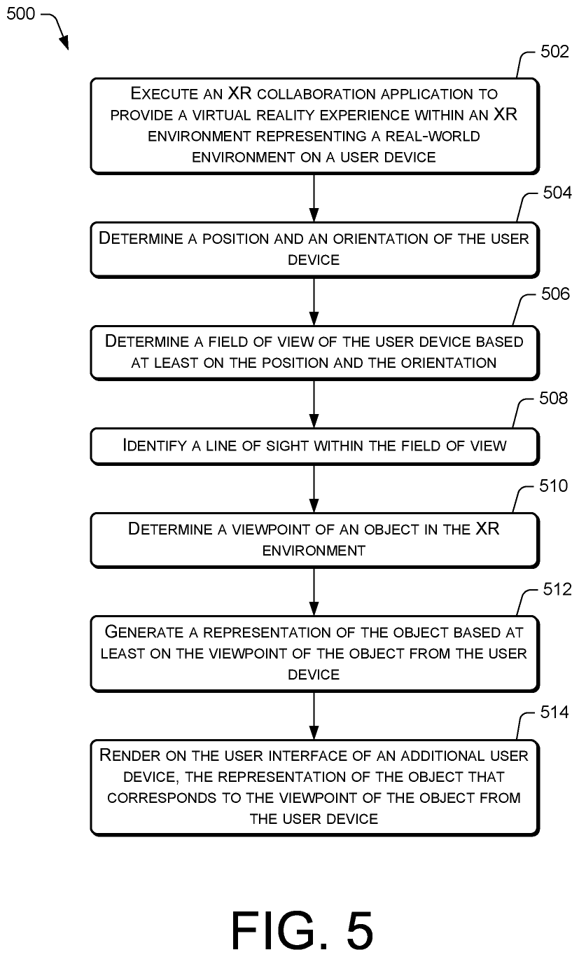

FIGS. 4 and 5 present illustrative processes 400-500 for providing coordinating operations in an XR environment for multiple users. The processes 400-500 are illustrated as a collection of blocks in a logical flow chart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the processes 400-500 are described with reference to FIGS. 1-3.

FIG. 4 is a flow diagram of an example process for sharing virtual experiences within an XR environment with multiple collaborators in different locations. At block 402, an XR collaboration application may be executed to provide a virtual reality experience within an XR environment representing a real-world environment at a remote location on a user device. The remote location can be a warehouse, a factory, a commercial space, a lab, and/or so forth. The user device can include any number of XR environment enabled user device associated with an XR author, a collaborator, and/or other types of application users.

At block 404, the XR collaboration application may render, on a user interface of the user device, a representation of an object within the XR environment at the remote location. The object may be a virtual or a real object that can be located at the remote location or another location. At block 406, the XR collaboration application may receive user input from an additional user device located at the remote location. The user input can include a user command to interact with the object. Additionally, the user input can include a user command to create, develop, and/or modify new or existing XR assets that may be associated with the object within the XR environment.

At block 408, in response to receiving the user input, the XR collaboration application may generate an edited representation of the object based at least on a viewpoint of the object from the additional user device. The viewpoint of the object may be unique to a user that operates the additional user device. At block 410, the XR collaboration application may render, on the user interface of the user device, the edited representation of the object that corresponds to the viewpoint of the object from the additional user device. The representation of the object may thereby be viewed from the first-person perspective or view of the user that interacts with the object.

FIG. 5 is a flow diagram of an example process for coordinating views of an object for multiple collaborators within an XR environment. At block 502, an XR collaboration application may be executed to provide a virtual reality experience within an XR environment representing a real-world environment at a remote location on a user device. The remote location may be various indoor and outdoor environments that may be commercial or residential. The user device can include any number of XR environment enabled user device associated with an XR author, a collaborator, and/or other types of application users.

At block 504, the XR collaboration application may determine the position and orientation of the user device. The position and orientation of the user device may be relative to an object in the XR environment. In some aspects, the XR collaboration application may determine its position based at least on its location coordinates and/or other location information. At block 506, the XR collaboration application may determine a field of view of the user device based at least on the position and the orientation of the user device. The object may be positioned within the field of view of the user device.

At block 508, the XR collaboration application may identify a line of sight to the object within the field of view. In some aspects, the line of sight may substantially correspond to a user's eye position. At block 510, the XR collaboration application may determine a viewpoint of an object in the XR environment. The viewpoint may be based at least on the position and the orientation of the user device and the line of sight to the object. At block 512, the XR collaboration application may generate a representation of the object based at least on the viewpoint of the object from the user device. Accordingly, the representation of the object may change if the viewpoint of the object changes. At block 514, the XR collaboration application may render, on the user interface of an additional user device, the representation of the object that corresponds to the viewpoint of the object from the user device. The user device and the additional user device may be located in different locations. The representation of the object may thereby be viewed from the first-person perspective or view of the user that interacts with the object.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

1. One or more non-transitory computer-readable media storing computer-executable instructions that upon execution cause one or more processors to perform acts comprising:
executing an XR collaboration application to provide a virtual reality experience within an XR environment representing a real-world environment at a remote location on a user device;
rendering, on a user interface of the user device, a representation of an object within the XR environment at the remote location;
capturing environmental data associated with the user device, the environmental data including at least one of a threshold temperature, threshold noise level, a threshold moisture level, or a threshold odor intensity;
receiving user input from an additional user device located at the remote location;
in response to receiving the user input and the environmental data, generating an edited representation of the object based at least on a viewpoint of the object from the additional user device; and
rendering, on the user interface of the user device, the edited representation of the object that corresponds to the viewpoint of the object from the additional user device.

2. The one or more non-transitory computer-readable media of claim 1, wherein the acts further comprise:
rendering, on an additional user interface of the additional user device, the representation of the object within the XR environment.

3. The one or more non-transitory computer-readable media of claim 1, wherein the acts further comprise:
receiving additional user input from the user device;
in response to receiving the additional user input, generating an additional representation of the object; and
rendering, on an additional user interface of the additional user device, the additional representation of the object.

4. The one or more non-transitory computer-readable media of claim 1, wherein the object is a virtual object.

5. The one or more non-transitory computer-readable media of claim 1, wherein the object and the user device are located at the same location.

6. The one or more non-transitory computer-readable media of claim 1, wherein the object is physically located at the remote location.

7. The one or more non-transitory computer-readable media of claim 1, wherein the acts further comprise:
determining a position and an orientation of the additional user device;
determining a field of view of the additional user device based at least on the position and the orientation of the additional user device;
identifying a line of sight to the object within the field of view; and
determining the viewpoint of the object based at least on the line of sight to the object.

8. A computer-implemented method, comprising:
executing an XR collaboration application to provide a virtual reality experience within an XR environment representing a real-world environment on a user device;
rendering, on a user interface of the user device, a representation of an object within the XR environment;
capturing environmental data associated with the user device, the environmental data including at least one of a threshold temperature, threshold noise level, a threshold moisture level, or a threshold odor intensity;
receiving user input from an additional user device located at a remote location;
in response to receiving the user input and the environmental data, generating an edited representation of the object based at least on a viewpoint of the object from the additional user device; and
rendering, on the user interface of the user device, the edited representation of the object that corresponds to the viewpoint of the object from the additional user device.

9. The computer-implemented method of claim 8, further comprising:
rendering, on an additional user interface of the additional user device, the representation of the object within the XR environment.

10. The computer-implemented method of claim 8, further comprising:
receiving additional user input from the user device;
in response to receiving the additional user input, generating an additional representation of the object; and
rendering, on an additional user interface of the additional user device, the additional representation of the object.

11. The computer-implemented method of claim 8, wherein the object is a virtual object.

12. The computer-implemented method of claim 8, wherein the object and the user device are located at the same location.

13. The computer-implemented method of claim 8, wherein the object is physically located at the remote location.

14. The computer-implemented method of claim 8, further comprising:
determining a position and an orientation of the additional user device;
determining a field of view of the additional user device based at least on the position and the orientation of the additional user device;
identifying a line of sight to the object within the field of view; and
determining the viewpoint of the object based at least on the line of sight to the object.

15. A system, comprising:
one or more non-transitory storage mediums configured to provide stored computer-readable instructions, the one or more non-transitory storage mediums coupled to one or more processors, the one or more processors configured to execute the computer-readable instructions to cause the one or more processors to:
execute an XR collaboration application to provide a virtual reality experience within an XR environment representing a real-world environment on a user device;
render, on a user interface of the user device, a representation of an object within the XR environment;
capture environmental data associated with the user device, the environmental data including at least one of a threshold temperature, threshold noise level, a threshold moisture level, or a threshold odor intensity;
receive user input from an additional user device located at a remote location;
in response to receiving the user input and the environmental data, generate an edited representation of the object based at least on a viewpoint of the object from the additional user device; and
render on the user interface of the user device, the edited representation of the object that corresponds to the viewpoint of the object from the additional user device.

16. The system of claim 15, wherein the one or more processors are further configured to:
render on an additional user interface of the additional user device, the representation of the object within the XR environment.

17. The system of claim 16, wherein the object is displayed as an overlay to the real-world environment or a hologram display.

18. The system of claim 15, wherein the one or more processors are further configured to:
receive additional user input from the user device;
in response to receiving the additional user input, generating an additional representation of the object; and
render on an additional user interface of the additional user device, the additional representation of the object.

19. The system of claim 15, wherein the object is a virtual object.

20. The system of claim 15, wherein the one or more processors are further configured to:
determine a position and an orientation of the additional user device;
determine a field of view of the additional user device based at least on the position and the orientation of the additional user device;
identify a line of sight to the object within the field of view; and
determine the viewpoint of the object based at least on the line of sight to the object.
